(19) United States
(12) Patent Application Publication
(10) Pub. No.: US 2026/0210877 A1
(43) Pub. Date: Jul. 23, 2026

(54) ORAL X-RAY IMAGING SYSTEM WITH INTEGRATED FILM AND X-RAY GUN ASSEMBLY FOR HANDS-FREE OPERATION

(71) Applicant: Emmad Sheikh, Murphy, TX (US)

(72) Inventor: Emmad Sheikh, Murphy, TX (US)

(21) Appl. No.: 19/031,770

(22) Filed: Jan. 18, 2025

(51) Int. Cl. G01N 23/04

(52) U.S. Cl. CPC G01N 23/04; G01N 2223/1016; G01N 2223/308; G01N 2223/32; G01N 2223/3303; G01N 2223/415; G01N 2223/6123

(57) ABSTRACT

An oral X-ray system is provided. The system comprises an X-ray gun configured to emit X-rays, an X-ray film configured to receive the X-rays emitted from the X-ray gun, a hollow semi-hoop structure including an upper portion and a lower portion such that the upper portion and the lower portion form a groove inside the hollow semi-hoop structure. The oral X-ray imaging system further comprises a connecting bar coupled to the X-ray gun and the X-ray film such that the X-ray gun and the X-ray film are coupled at opposite ends of the connecting bar, the connecting bar is rotatably coupled to the X-ray gun, a rolling wheel is connected to the connecting bar at a position between the X-ray gun and the X-ray film, and the rolling wheel is positioned in the groove to freely move along the circumference and inside the hollow semi-hoop structure.

### DESCRIPTION

### Technical Field

This disclosure relates to the field of dental radiography. More specifically, it concerns an oral X-ray imaging system designed to improve the efficiency of capturing dental and oral cavity X-ray images by integrating the X-ray transmitter and the X-ray film in a single assembly.

### Background

In dental practices, obtaining X-ray images of a patient's teeth and jaw requires the precise placement of an X-ray film or RVG (Radio Visio Graph) sensor inside the patient's mouth, aligned with the X-ray gun. Typically, the patient or an additional assistant is required to hold the film or sensor in place, which introduces challenges in ensuring proper positioning, maintaining stillness, and preventing exposure inaccuracies. These challenges often lead to repeated X-ray captures, unnecessary radiation exposure, and patient discomfort.

Various devices have been proposed to streamline the X-ray capturing process; however, they still require external assistance for sensor positioning or lack adequate control over the alignment of the X-ray source and receiver. Therefore, a need exists for an X-ray assembly which can be positioned and operated more effectively within the patient's mouth.

### SUMMARY

An oral X-ray system comprises an X-ray transmitter that is used to transmit X-rays generated by an X-ray source. An X-ray film arranged to receive the X-rays transmitted from the X-ray transmitter. The oral X-ray system further comprises a hollow container including an upper portion and a lower portion. The X-ray transmitter is disposed inside the hollow container and between the upper portion and the lower portion. The hollow container is designed to be placed in between an upper jaw and a lower jaw within a mouth of a user. The front facing side of the upper portion and the lower portion forms a groove inside the hollow container at the front facing side of the hollow container. The front facing side of the hollow container is semi-circular and the groove is formed along a circumference of the front facing side of the hollow container. A connecting bar coupled to the X-ray transmitter and the X-ray film, such that the X-ray transmitter and the X-ray film are coupled at opposite ends of the connecting bar. Further a rolling wheel is coupled to the connecting bar at a position between the X-ray transmitter and the X-ray film. The rolling wheel is positioned in the groove to freely move along the circumference of the front facing side of the hollow container.

In an embodiment, the X-ray source is integrated with the X-ray transmitter and configured to be placed inside the mouth of the user.

In another embodiment, the X-ray source is operable to supply the generated X-rays to the X-ray transmitter via an optical fibre, such that the X-ray source is positioned outside the mouth of the user, and the X-ray transmitter is positioned inside the mouth of the user.

In an embodiment, the X-ray film is designed to be placed inside the user's mouth.

In an embodiment, the connecting bar includes an X-ray film holder configured to hold the X-ray film.

In another embodiment, the X-ray film holder is rotatably coupled with the connecting bar.

In an embodiment, the X-ray film holder is rotatable by a user applying a rotational force.

In an embodiment, the connecting bar comprises a telescopic arm, and a length of the connecting bar is adjustable through linear actuation of the telescopic arm.

In a further embodiment, comprising an activation switch wirelessly coupled to the X-ray source, wherein the activation switch is configured to activate the X-ray source based on an input provided by the user.

### BRIEF DESCRIPTION OF THE DRAWINGS

The present application can be best understood by reference to the following description taken in conjunction with the accompanying drawing figures, in which like parts may be referred to by like numerals.

FIG. 1 illustrates an oral X-ray imaging system with a rotatable connecting bar connected to an X-ray source integrated with an X-ray film, in accordance with an embodiment of the present disclosure.

FIG. 2A illustrates an example scenario of an X-ray film adjustment, in accordance with an embodiment of the present disclosure.

FIG. 2B illustrates an example scenario of an X-ray film adjustment, in accordance with an embodiment of the present disclosure.

FIG. 3 illustrates an oral X-ray imaging system with the X-ray source placed outside the mouth, in accordance with an embodiment of the present disclosure.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

The present invention relates to an oral X-ray imaging system that offers a solution to the common challenge faced by dentists capturing high-quality X-ray images without the need for an additional person to hold the X-ray film or RVG sensor inside the patient's mouth. The invention provides an integrated system that eliminates the need for manual assistance, allowing the dentist to handle both the X-ray source and film placement with ease. The system is particularly beneficial in clinical environments where accuracy, precision, and speed are of utmost importance, such as in diagnosing oral diseases or planning complex dental treatments. This self-sufficient system improves workflow efficiency while also enhancing patient comfort by reducing the need for continuous manual adjustments.

The invention is described in terms of particular examples and illustrative figures; this innovation addresses the challenge of maintaining proper alignment between the X-ray source and the X-ray film, ensuring that high-quality diagnostic images can be obtained easily and accurately. The system is particularly useful in dental settings where image accuracy and patient comfort are critical.

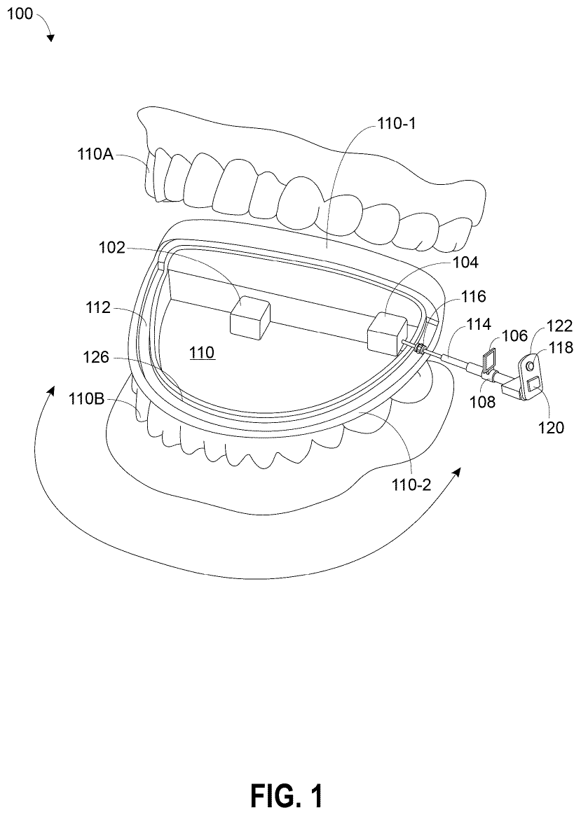

FIG. 1 illustrates an oral X-ray imaging system with a rotatable connecting bar connected to an X-ray source integrated with an X-ray film, in accordance with an embodiment of the present disclosure. With reference to FIG. 1, there is shown an oral-X-ray-imaging system 100. The oral X-ray system 100 may include an X-ray source 102, an X-ray transmitter 104, an X-ray film 106, an X-ray film holder 108, a hollow container 110, a semi-circular groove 112 in front side of the hollow container 110, a connecting bar 114, a rolling wheel 116, a wireless switch 118, and a communication module 120.

The oral X-ray imaging system 100 comprises the X-ray transmitter 104 disposed within the hollow container 110 which is placeable inside the user's mouth. The X-ray transmitter 104 is responsible for emitting or transmitting X-rays towards the target area. It is operatively connected to an X-ray source 102 generating the X-rays. In a specific example, the X-ray source 102 may be connected to the X-ray transmitter 104 via an optical fiber such that the X-rays generated by the X-ray source 102 are transferred to the X-ray transmitter 104 which focuses those X-rays towards the target area. In another example, the X-ray source 102 may be mechanically coupled to the X-ray transmitter 104 to focus the X-rays generated by the X-ray source 102 towards the target area. In a specific embodiment, the X-ray source 102 may be integrated with the X-ray transmitter 104. In effect, both the X-ray source 102 and transmitter 104 may be housed within the hollow structure 110 inside the mouth. This design eliminates the need for external equipment connected to the transmitter and allows for efficient and direct transmission of X-rays from within the oral cavity, improving accuracy and reducing interference from external elements.

Opposite to the X-ray transmitter 104, there is an X-ray film 106, which is designed to receive and capture the X-rays emitted by the X-ray transmitter 104. The X-ray film 106 acts as the recording medium for the X-ray images, which can then be used for diagnostic purposes. The X-ray film 106 is securely held in place by an X-ray film holder 108. The X-ray film holder 108 not only secures the film but also allows for precise positioning and orientation of the X-ray film 106 with respect to an area of the mouth to be photographed using the X-rays transmitted from the X-ray transmitter 104.

X-ray films 106 are typically made of a polyester plastic base coated with photosensitive silver halide crystals embedded in a gelatin emulsion. When exposed to X-rays, the silver halide crystals react to form a latent image, which can then be chemically processed to produce a visible radiograph. In modern dental practices, digital sensors, such as RVG (Radio Visio Graph) sensors, have largely replaced traditional X-ray films 106. These RVG sensors are made of durable materials like silicon or amorphous selenium. The sensor array inside the RVG device converts the X-ray radiation into an electronic signal, which is then digitally processed to create an image in real-time.

The X-ray film holder 108 is rotatably coupled to the connecting bar 114. This rotatable coupling allows the X-ray film 106 to be adjusted easily, permitting the rotation of the X-ray film 106 to capture X-rays emitted from the X-ray transmitter 104 from various angles and locations. The X-ray film holder 108 is rotatable by a user applying a rotational force. This rotation capability is critical for adjusting the angle and positioning of the film to align perfectly with the emitted X-rays, ensuring that a clear and accurate image is captured, regardless of the film's initial orientation. The rotatable feature provides flexibility and allows the operator to make fine adjustments to capture images from different angles.

The hollow container 110 is designed to support and guide the movement of the X-ray transmitter 104 and X-ray film 106. The hollow container 110 is placed between the upper jaw 110A and the lower jaw 110B of the user, fitting comfortably inside the mouth. The container holds the integrated X-ray source 102 and X-ray transmitter 104 in a stable position, ensuring they do not shift or move unintentionally during the procedure. By placing the hollow container 110 between the jaws, it also helps to maintain a fixed spatial relationship between the upper jaw 110A and lower jaw 110B, improving the stability and accuracy of the image capture process.

The hollow structure 110 includes an upper portion 110-1 and a lower portion 110-2. The hollow structure 110 is semicircular at the front i.e. the side near an opening of the mouth. In other words, the hollow structure 110 is strategically designed such that its semi-circular front facing side is positioned near the opening of the mouth.

In an embodiment, on the front side, the upper portion 110-1 and lower portion 110-2 are parts of the hollow structure 110, that are designed to be positioned between the user's upper jaw 110A and lower jaw 110B. The upper portion 110-1 aligns with the upper jaw 110A, while the lower portion 110-2 aligns with the lower jaw 110B. Together, they stabilize the X-ray components, ensuring accurate positioning of the X-ray transmitter 104 and X-ray film 106. Additionally, there is a semi-circular groove 112 that extends along the circumference of the hollow container 110. This groove 112 functions as a guide rail for the rolling wheel 116, which is attached to the connecting bar 114. The rolling wheel 116 is positioned so that it fits into the groove 112 and can move freely along the length of the groove 112.

In an embodiment, the hollow container 110 is designed to be placed between the upper jaw 110A and lower jaw 110B of the user during an oral X-ray procedure. It is constructed from biocompatible, durable materials that ensure it can comfortably fit within the mouth while maintaining structural integrity throughout the imaging process. The upper portion 110-1 and the lower portion 110-2 together form a cohesive structure that holds the integrated X-ray components.

The upper and lower portions 110-1, 110-2 of the hollow container 110 are integrally connected or assembled using a fixed coupling mechanism such as interlocking tabs, screws, or adhesive bonding. These portions are aligned to create a continuous cavity or groove through which the connecting bar 114 and rolling wheel 116 can move. The hollow container's interior walls are smooth and non-abrasive to prevent any irritation or injury to the user's oral cavity during use.

The hollow container's front-facing side 126, which is designed to be positioned near the opening of the mouth, is semi-circular in shape. This semi-circular front is crucial for maintaining a snug fit within the user's mouth and aligning the X-ray transmitter 104 and X-ray film 106 for optimal imaging. The curvature of the semi-circular front is designed to match the natural contour of the mouth, reducing discomfort while ensuring that the container remains securely in place during the procedure.

The hollow container includes integrated mounting points for securely attaching the X-ray transmitter 104 and X-ray source 102. These mounting points may be in the form of clamps, snap-fit brackets, or screw mounts, depending on the specific configuration of the X-ray components. The mounting points are positioned to maintain a fixed spatial relationship between the X-ray transmitter 104 and X-ray film 106, ensuring accurate and repeatable positioning for image capture.

The outer surface of the hollow container 110 is contoured to minimize discomfort during use. The semi-circular front-facing side is smooth and rounded, allowing the container to fit comfortably between the upper and lower jaws without causing pressure points. The overall size of the container is designed to accommodate a wide range of mouth sizes, and the semi-circular groove ensures proper alignment within the oral cavity.

The hollow container 110 is constructed from a medical-grade polymer or composite material that is lightweight yet strong enough to withstand repeated use. The material is also radiolucent, allowing X-rays to pass through without interference. The container's surface is treated to be non-porous and easy to clean, meeting hygienic standards required for intraoral medical devices.

The groove 112 is formed along the circumference of the semi-circular front-facing side of the hollow container. This groove 112 is strategically positioned to accommodate the rolling wheel 116 that is coupled to the connecting bar 114. The groove's dimensions are slightly wider than the diameter of the rolling wheel, allowing the wheel to move freely along the circumference of the hollow container without dislodging. The walls of the groove 112 are reinforced to provide resistance against wear and ensure that the rolling wheel remains securely seated within the groove even when the connecting bar 114 rotates.

The connecting bar 114 includes a telescopic arm and the length of the connecting bar is adjustable through linear actuation of the telescopic arm. The connecting bar 114 is coupled to the X-ray transmitter 104 and the X-ray film 106. One end of the connecting bar 114 is attached to the X-ray transmitter 104, while the opposite end is connected to the X-ray film 106 via the film holder 108. The connecting bar serves as a structural link between these components, ensuring they remain aligned and can move together as a unit.

In an embodiment, the connecting bar 114 is a telescopic and adjustable component designed to integrate the X-ray film 106 with the X-ray transmitter 104. In effect, the connecting bar 114 eliminates the need for manual handling of the X-ray film during the imaging process, ensuring stable positioning of both the X-ray transmitter and X-ray film for accurate and repeatable image capture.

The connecting bar 114 is composed of two or more telescopic segments, which enable linear extension and retraction. These segments are nested inside one another, allowing the bar's length to be adjusted as needed to accommodate various jaw sizes or different imaging angles. The telescopic action is smooth and frictionless, utilizing precision-fit sliding components or a low-friction bushing system. The bar can extend or retract manually by applying a linear force, or it can include a locking mechanism that secures the desired length in place once adjusted. The locking mechanism may consist of spring-loaded detents or friction-based clamps, preventing unintentional movement of the bar once the length is set. This ensures the X-ray film 106 and X-ray transmitter 104 maintain a fixed distance from each other, optimizing image quality.

At one end of the connecting bar 114, the X-ray film holder 108 is attached. The holder 108 is designed to securely accommodate the X-ray film 106 and is either integrally moulded or mechanically fastened to the bar. The film holder 108 may include snap-fit brackets, clamps, or adhesive pads to hold the X-ray film 106 in place without slippage or movement during the imaging process. The film holder 108 is rotatably coupled with the bar 114, allowing the X-ray film 106 to be adjusted to different angles relative to the transmitter for various imaging perspectives. The rotatable coupling is facilitated through a pivoting joint or bearing assembly at the connection point between the holder 108 and the bar 114. This feature enables easy manual rotation of the X-ray film 106 by the user, ensuring precise positioning without the need for additional tools.

The opposite end of the connecting bar 114 is coupled to the X-ray transmitter 104. This coupling is rigid and secure, ensuring that the X-ray transmitter 104 remains aligned with the X-ray film 106 during use. The connection between the bar 114 and the X-ray transmitter 104 may include a threaded joint, clamp, or snap-fit design that allows for easy assembly and disassembly. The connecting bar 114 transmits any mechanical adjustments directly to the X-ray transmitter 104, enabling synchronized movement of both the X-ray film 106 and the X-ray transmitter 104. This alignment ensures that the X-rays emitted from the X-ray transmitter 104 are properly directed towards the film for optimal image capture.

Additionally, the connecting bar 114 features a rolling wheel 116 positioned between the X-ray transmitter 104 and the X-ray film 106. The rolling wheel 116 is coupled to the bar 114 such that the bar 114 passes through the axis of the wheel 116. This arrangement ensures that the wheel 116 remains centered and aligned with the groove 112 formed in the hollow container 110, even when the bar 114 rotates. The rolling wheel 116 allows the bar 114 to rotate freely within the groove 112, enabling the X-ray film 106 and X-ray transmitter 104 to adjust their positions smoothly along the semi-circular path defined by the groove 112 in the hollow container 110. The wheel 116 is attached to the bar 114 using a low-friction bearing assembly that allows for rotational movement without causing displacement of the wheel 116 from the groove 112.

The connecting bar 114 is constructed from a lightweight, durable material such as stainless steel or high-strength polymer to withstand the forces of rotation and extension without bending or deforming. The surface of the bar 114 is treated to be smooth and non-abrasive, reducing friction and ensuring ease of movement both within the telescopic sections and during rotation. The materials used are also biocompatible and sterilizable, meeting medical-grade standards for intraoral use.

The rolling wheel 116, which is positioned along the connecting bar 114, facilitates the smooth movement of the entire assembly. The wheel 116 sits in the semi-circular groove 112 of the hollow container 110 and enables the connecting bar 114 to move along the circumference of the container. This rolling feature allows the X-ray transmitter 104 to be repositioned easily within the user's mouth. As the rolling wheel 116 travels along the groove 112, the system can be rotated or adjusted to capture X-rays from multiple angles without the need for manual repositioning of the components or the patient.

To prevent unwanted movement of the rolling wheel 116 during the procedure, the groove 112 may be equipped with a detent mechanism or sealing feature that engages the wheel 116 at specific positions. This detent can be in the form of slight protrusions within the groove that provide resistance at predefined intervals, allowing the wheel to “lock” into place when necessary while still allowing for free movement when force is applied.

To provide stability and prevent flexing during use, internal support ribs or struts may be incorporated along the inner surfaces of the hollow container 110. These support structures are positioned to reinforce the semi-circular front-facing side, ensuring that the groove 112 remains dimensionally stable and does not deform under pressure from the rolling wheel. The support ribs are designed to be thin enough to not interfere with the rolling wheel's movement while still providing the necessary structural rigidity.

In an embodiment, the wireless activation switches 118 that are integrated into the oral X-ray imaging system 100, enhances the usability and functionality of the X-ray source 102. This wireless switch 118 is designed to allow the user to activate the X-ray source 102 remotely, facilitating a more convenient and efficient imaging process.

The activation switch 118 is wirelessly coupled to the X-ray source 102, allowing the user to trigger the emission of X-rays without needing to physically interact with the X-ray source 102 or the X-ray transmitter 104 directly. This feature is particularly beneficial in a clinical setting, where the operator may need to maintain a safe distance from the patient during imaging procedures. The wireless operation minimizes the risk of accidental exposure to radiation for both the user and the patient.

In an embodiment, the wireless switch 118 features a simple interface, such as buttons or touch-sensitive controls, allowing the user to activate the X-ray source 102 with ease. Upon receiving input, the switch 118 sends a wireless signal using communication technologies like Bluetooth, Wi-Fi, or radio-frequency protocols, eliminating the need for physical wiring and providing flexibility in switch placement.

Further, the signal is received by the communication module 120, which acts as a bridge between the wireless switch 118 and the X-ray source 102. The communication module 120 may include key components such as a receiver unit that picks up the wireless signal, and a microcontroller that processes the signal and determines whether to activate the X-ray source 102. The microcontroller ensures safety and accuracy by confirming valid activation before triggering the X-ray emission.

The communication module 120 may employ various communication protocols, such as Bluetooth, Wi-Fi, NFC (Near Field Communication), Zigbee, or cellular networks (e.g., 3G, 4G, 5G), to transmit data wirelessly. In certain embodiments, the communication module may also support wired communication through interfaces such as USB, Ethernet, or other suitable data transfer methods

In an embodiment, the communication module 120 operates using wireless technologies such as Bluetooth, Wi-Fi, or other RF-based protocols, enabling remote control while maintaining secure and consistent connectivity. The communication module 120 may include a transmitter to send feedback or status updates to the user, a power supply to ensure consistent operation. Once the activation signal is processed, the X-ray source 102 is promptly triggered, allowing real-time control and ensuring safe, efficient operation without direct physical interaction with the X-ray equipment.

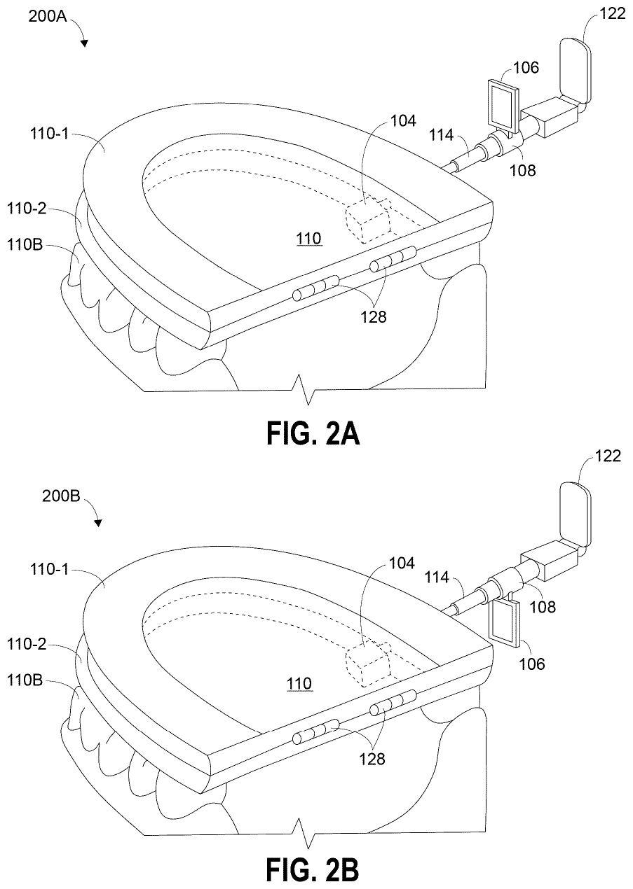

FIG. 2A and FIG. 2B illustrate example scenarios of an X-ray film adjustment, in accordance with an embodiment of the present disclosure. With reference to FIG. 2A and FIG. 2B, there are shown an oral X-ray-imaging system 200A and 200B. The oral X-ray imaging system 200A and 200B are particularly aimed at highlighting the positioning of the X-ray film 106 for capturing images of the lower jaw 110B and upper jaw 110A respectively.

In an embodiment, FIG. 2A illustrates a perspective view of the front facing side 126 of the hollow container 110 as it is positioned inside the patient's mouth. There is a hinge 128 that allows the upper portion 110-1 and lower portion 110-2 portion of the hollow container 110 to open and close easily. This provides convenient access to the inside of the container for adjustments or component placement. The connecting bar 114 is shown inserted between the upper portion 110-1 and the lower portion 110-2 of the hollow container 110. The connecting bar 114 is held securely within the groove 112 of the hollow container 110. In effect, the X-ray source 102 and X-ray transmitter 104 is securely positioned inside the mouth of the patient. The X-ray transmitter 104 and the X-ray film 106 are coupled at opposite ends of the connecting bar 114 which extends outwards the mouth and leading towards the X-ray film 106.

In an embodiment, the connecting bar 114 has an X-ray film holder 108 which is used to hold the X-ray film 106. The X-ray film holder 108 is designed to be manually rotated, allowing the user to adjust its position for capturing X-ray images of the upper jaw 110A. The X-ray film holder 108 is securely connected to the connecting bar 114, which supports its rotation. By manually adjusting the film holder, the system ensures precise positioning of the X-ray film, enabling accurate imaging of different areas within the mouth. The connecting bar 114 is equipped with a telescopic arm, which allows its length to be adjusted. Through linear actuation, the telescopic arm can be extended or retracted, providing flexibility in positioning the X-ray transmitter 104 and X-ray film 106. This adjustability ensures precise alignment within the mouth for optimal imaging.

In an embodiment, the handle 122 which is designed to be manually rotated by the user, is attached to the outer end of the connecting bar 114, providing a grip for easy manipulation. The connecting bar 114 features a rolling wheel 116, which is positioned within the groove 112 of the hollow container 110. This rolling wheel 116 moves freely along the groove's 112 circumference, allowing smooth movement of the connecting bar 114. This setup helps in accurately positioning the X-ray transmitter 104 and X-ray film 106 to capture X-ray images of any teeth inside the mouth from various angles.

In a specific arrangement as illustrated in FIG. 2A, the X-ray film 106 is positioned to capture detailed images of the upper jaw 110A ensuring proper alignment with the X-ray transmitter 104 for imaging. The hollow container 110 structure helps stabilize the positioning of the X-ray transmitter 104 during the imaging process.

In a further embodiment as illustrated in FIG. 2B, another view of the hollow container 110 is illustrated, similarly showing the X-ray film 106 as positioned between the upper portion 110-1 and the lower portion 110-2 of the hollow container 110. In a specific arrangement as illustrated in FIG. 2B, the X-ray film 106 is positioned to capture detailed images of the lower jaw 110B ensuring proper alignment with the X-ray transmitter 104 and X-ray film 106 for imaging. FIG. 2B emphasizes how the hollow container 110 that provides consistent and precise positioning of the X-ray film 106 and X-ray transmitter 104 which is coupled with the telescopic connecting bar 114 with the patient's oral cavity, ensuring that the film remains steady for clear imaging results.

In a further embodiment, the connecting bar 114 is embedded with the X-ray film holder 108 which is designed to rotate up to 180 degrees manually to enable the X-ray film 106 to take images of the opposite side of the jaw, without needing to reposition the entire apparatus. Additionally, when a 180-degree rotation is achieved, the X-ray film 106 moves from one side of the patient's mouth to the other, enabling imaging of the opposite side of the jaw. This rotation is facilitated by the X-ray film holder 108, allowing adjustment for capturing images of both the upper jaw 110A and lower jaw 110B. It is securely connected to the connecting bar 114, supporting its movement. These manual rotation arrangements ensure that the X-ray film 106 can be quickly and precisely repositioned for optimal imaging of either side of the patient's jaw.

Both FIG. 2A and FIG. 2B demonstrate the utility of the hollow container 110 in ensuring proper alignment of the X-ray film 106 during imaging. The hollow container 110 allows the X-ray film 106 to be positioned in close proximity to the upper jaw 110A and lower jaw 110B for optimal imaging results while maintaining patient comfort.

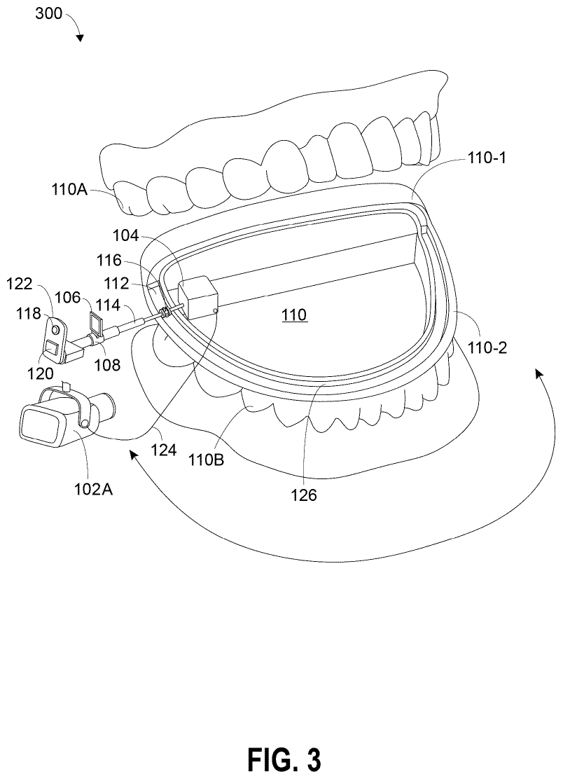

FIG. 3 illustrates the oral X-ray imaging system with the X-ray source placed outside the mouth, in accordance with an embodiment of the present disclosure. With reference to the FIG. 3, there is shown an oral X-ray imaging system 300 with an X-ray source 102A placed outside the mouth. The X-ray source 102A generates X-rays and transmits them via an optical fiber 124 to the X-ray transmitter 104, which is positioned inside the hollow structure 110. It is noted here that functionality of 102 and 102A are similar and can be used interchangeably. The optical fiber 124 serves as a conduit, ensuring the safe and efficient transfer of X-rays from the external source to the X-ray transmitter 104 within the mouth. The hollow container 110, comprising the upper portion 110-1 and lower portion 110-2, supports the positioning of the X-ray transmitter 104 and the X-ray film 106. This configuration allows the X-ray source 102A to remain outside, minimizing discomfort for the user while enabling precise image capture within the mouth. The manual rotation of the handle 122 aids in adjusting the X-ray system for capturing images of different teeth as explained already in FIG. 2.

Additionally, optical fibers 124 specifically used to transmit X-rays are capable of handling high-energy radiation efficiently while maintaining the integrity and precision of the X-ray beam. Generally, optical fibers used to transmit X-rays must be capable of handling high-energy radiation efficiently while maintaining the integrity and precision of the X-ray beam.

Generally, quartz optical fibers or silica-based fibers can be used, as these materials have excellent transparency to X-ray radiation and can withstand high radiation doses. Hollow-core optical fibers are another option, which use a reflective internal coating to guide the X-rays through the hollow container 110, minimizing absorption losses and ensuring higher transmission efficiency. These types of fibers are often chosen for medical imaging applications because they balance flexibility with high transmission quality.

In addition, metal-coated optical fibers or polymer-clad fibers may be used to enhance the robustness and flexibility of the system. These coatings provide additional shielding to the fiber, protecting it from external damage and ensuring that the X-rays are effectively guided toward the X-ray transmitter 104 inside the mouth.

The fundamental principle by which an optical fiber transmits X-rays is total internal reflection. Optical fibers typically consist of a core and a cladding layer with differing refractive indices. In the case of traditional light-based fibers, when light (or, in this case, X-ray radiation) enters the fiber, it is continuously reflected off the internal walls of the core, staying confined within the fiber due to total internal reflection. This enables the X-rays to travel long distances with minimal energy loss. For X-ray-transmitting optical fibers 124, the materials used for the core and cladding must be transparent to X-ray radiation, enabling efficient transmission without significant attenuation or scattering of the X-ray photons.

In a further embodiment, the separation of the X-ray source 102A from the components inside the mouth reduces discomfort for the user, while the optical fiber 124 ensures seamless X-ray transmission from the external source to the internal X-ray transmitter 104.

Therefore, the oral X-ray imaging system 300 that enhances dental imaging efficiency and patient comfort. By positioning the X-ray source 102A outside the mouth, it reduces discomfort while allowing precise imaging of both the upper jaw 110A and lower jaw 110B. Overall, this innovative approach streamlines the imaging process, improving the overall patient experience and diagnostic accuracy and making it easier for dental professionals to obtain high-quality images quickly.

What is claimed is:

1. An oral X-ray system, comprising:
an X-ray transmitter configured to transmit X-rays generated by an X-ray source;
an X-ray film configured to receive the X-rays transmitted from the X-ray transmitter;
a hollow container including an upper portion and a lower portion, wherein
the X-ray transmitter is disposed inside the hollow container and between the upper portion and the lower portion,
the hollow container is configured to be placed between an upper jaw and a lower jaw within a mouth of a user,
a front facing side of the upper portion and the lower portion form a groove inside the hollow container at a front facing side of the hollow container,
the front facing side of the hollow container is semi-circular,
the groove is formed along a circumference of the front facing side of the hollow container;
a connecting bar coupled to the X-ray transmitter and the X-ray film, wherein
the X-ray transmitter and the X-ray film are coupled at opposite ends of the connecting bar,
a rolling wheel is coupled to the connecting bar at a position between the X-ray transmitter and the X-ray film,
the rolling wheel is positioned in the groove to freely move along the circumference of the front facing side of the hollow container.

2. The system of claim 1, wherein the X-ray source is integrated with the X-ray transmitter and disposed inside the hollow container.

3. The system of claim 1, wherein
the X-ray source is configured to supply the generated X-rays to the X-ray transmitter via an optical fibre,
the X-ray source is positioned outside the mouth of the user, and
the X-ray transmitter is positioned inside the mouth of the user.

4. The system of claim 1, wherein the X-ray film is configured to be placed within the mouth of the user.

5. The system of claim 1, wherein the connecting bar includes an X-ray film holder configured to hold the X-ray film.

6. The system of claim 1, wherein the X-ray film holder is rotatably coupled with the connecting bar.

7. The system of claim 1, wherein the X-ray film holder is rotatable by the user applying a rotational force.

8. The system of claim 1, wherein
the connecting bar includes a telescopic arm, and
a length of the connecting bar is adjustable through linear actuation of the telescopic arm.

9. The system of claim 2, further comprising an activation switch wirelessly coupled to the X-ray source, wherein the activation switch is configured to activate the X-ray source based on an input provided by the user.
